(19) United States
(12) Patent Application Publication
(10) Pub. No.: US 2021/0173049 A1
(43) Pub. Date: Jun. 10, 2021

(54) METHOD AND LIDAR DEVICE FOR SCANNING A SCANNING AREA USING BEAMS HAVING AN ADJUSTED WAVELENGTH

(71) Applicant: Robert Bosch GmbH, Stuttgart (DE)

(72) Inventors: Hans-Jochen Schwarz, Stuttgart (DE); Nico Heussner, Ludwigsburg (DE); Siegwart Bogatscher, Leonberg (DE); Stefan Spiessberger, Weinstadt (DE)

(73) Assignees: Robert Bosch GmbH, Stuttgart (DE); Robert Bosch GmbH, Stuttgart (DE)

(21) Appl. No.: 16/616,810

(22) PCT Filed: May 22, 2018
(86) PCT No.: PCT/EP2018/063271

§ 371 Date: Nov. 25, 2019

(30) Foreign Application Priority Data
May 26, 2017 (DE) 10 2017 208 898.2

(51) Int. Cl. G01S 7/481; G02B 27/42

(52) U.S. Cl. CPC G01S 7/4815; G02B 27/4233

(57) ABSTRACT

A LIDAR device for scanning a scanning area using at least two beams includes at least two beam sources for generating at least two beams, a generating optics for shaping the at least one generated beam, a receiving unit for receiving and evaluating at least one beam reflected on an object, and an optical bandpass filter for absorbing spurious reflections, each beam source generating at least one beam having a wavelength that is adjustable depending on an emission angle of the at least one beam.

### CROSS-REFERENCE TO RELATED APPLICATIONS

The present application is the national stage of International Pat. App. No. PCT/EP2018/063271 filed May 22, 2018, and claims priority under 35 U.S.C. § 119 to DE 10 2017 208 898.2, filed in the Federal Republic of Germany on May 26, 2017, the content of each of which are incorporated herein by reference in their entireties.

### FIELD OF THE INVENTION

The present invention relates to a LIDAR device for scanning a scanning area using at least two beams, and to a method for scanning the scanning area using at least two beams.

### BACKGROUND

Typical LIDAR (Light Detection and Ranging) devices are made up of a transceiver unit. The transmitting unit generates and emits electromagnetic beams continuously or in a pulsed manner. If these beams impact a movable or stationary object, the beams are reflected by the object in the direction of the receiving unit. The receiving unit can detect the reflected electromagnetic radiation and assign a received time to the reflected beams. This can be utilized, for example, within the scope of a “time-of-flight” analysis for an ascertainment of a distance of the object to the LIDAR device. In order to improve the signal-to-noise ratio, optical bandpass filters, in particular interference filters, can be situated in the reception path of the LIDAR device in order to filter out spurious reflections. The narrower the transmitted wavelength range of the filter is, the less interfering or ambient light falls onto the detector and the better the signal quality is. Upon detection of beams having an incidence angle greater than 0° in relation to an optical axis, a displacement of the transmitted wavelength range toward smaller wavelengths occurs. Therefore, filters having a broader transmitted wavelength range must be utilized, so that beams having incidence angles deviating from an optical axis can be transmitted for reception. A filter having a broader transmitted wavelength range can have an adverse effect on the signal-to-noise ratio in this case.

### SUMMARY

An object underlying the present invention can be considered that of creating a method and a LIDAR device that allow for a utilization of a filter having a smaller transmitted wavelength range and include an improved signal-to-noise ratio.

According to one aspect of the present invention, a LIDAR device for scanning a scanning area using at least two beams includes at least two beam sources for generating at least two beams, as well as a generating optics for shaping the at least two generated beams. A deflection unit is utilized for variably deflecting the at least one beam along the scanning area. Alternatively, the deflection can be implemented by rotating the complete transmitting unit. At least one beam reflected on an object can be received and evaluated by a receiving unit of the LIDAR device.

Moreover, the LIDAR device includes an optical bandpass filter for absorbing spurious reflections, each beam source generating at least one beam having a wavelength that is adjustable depending on an emission angle of the at least one beam.

The at least two beam sources are situated at a distance to one another and therefore also generate beams that are spaced apart from one another. For the sake of simplicity, “beams” are to be understood within the scope of “at least two beams.” The beams are subsequently shaped by a generating optics. The generating optics can be, for example, an optical element in the form of a lens. For example, the generating optics can be a coated or uncoated cylindrical lens, a convex lens, a concave lens, or a combination of multiple identical or different lenses. Using the generating optics, the generated beams can be bundled or fanned out. Beams situated at a distance from an optical axis of the generating optics have an emission angle after passing through the generating optics. The emission angle is dependent, in particular, on the optical properties of the generating optics and the distance from the optical axis. Beams shaped in this way can be subsequently emitted from the LIDAR device into the scanning area directly or via a deflection unit. Preferably, the beams can be deflected along a horizontal angle and a vertical angle in a meandering manner. As a result, the scanning area that is covered by the horizontal angle and the vertical angle, can be scanned using the generated and shaped beams.

Provided that an object is situated in the scanning area, the shaped and emitted beams are reflected on the object. At least one beam reflected on the object also has a larger reflection angle in this case. The at least one reflected beam can be received and detected by the receiving unit. For this purpose, the receiving unit preferably includes a receiving optics that deflects the at least one reflected beam onto a detector. An optical bandpass filter is additionally situated in the reception path. The filter can be situated, for example, upstream from the receiving optics, within the receiving optics, or downstream from the receiving optics, originating from the incoming reflected beam. The filter is usually an interference filter that has a transmission unit for beams of a certain wavelength range. The transmitted wavelength range of the filter shifts depending on an incidence angle of the reflected beams with respect to the filter.

In particular, the transmitted wavelengths of the filter become smaller as the incidence angle of a reflected incoming beam increases. Incoming beams having a wavelength outside the transmitted wavelength range can be reflected by the filter of the LIDAR device or absorbed by the filter. In the case of the LIDAR device according to the present invention, the wavelength of at least one generated beam or shaped beam is adjustable depending on its emission angle by way of passing through the generating optics. The selection of the wavelengths takes place according to the utilized optical bandpass filter in the reception path of the LIDAR device.

Preferably, the wavelength of at least one generated or shaped beam is adjustable in such a way that the wavelength corresponds to the wavelength shift of the transmitting wavelength range of the optical bandpass filter after a reflection of the beam on an object. At least one generated beam that is spaced apart from the optical axis of the generating optics can have, for example, a smaller wavelength and, therefore, despite a resultant larger incidence angle with respect to the optical bandpass filter, can lie within the transmitted wavelength range and preferably transmit through the filter in a loss-free manner. As a result, in particular, the transmitted wavelength range can be designed to be smaller so that fewer spurious reflections can pass through the filter and be registered by the detector. Multiple reflections from the surroundings that impact the receiving unit and the filter at different angles can also be more effectively blocked by an optical bandpass filter having a smaller transmitted wavelength range. Resulting therefrom is also a reduced likelihood of the LIDAR device detecting “ghost objects.” Moreover, the signal-to-noise ratio of the LIDAR device can be improved using a smaller transmitted wavelength range of the filter. Alternatively or additionally, generated beams having larger emission angles can also be utilized in order to allow for a larger scanning area.

According to an example embodiment of the LIDAR device, the wavelength of the at least one beam is adjustable using the at least one beam source. For example, different beam sources can be utilized. The beam sources can be different lasers, such as semiconductor lasers that can generate beams having a different wavelength in each case. In this way, an adaptation of the wavelengths of the generated beams can be implemented in a technically simple way.

According to a further example embodiment of the LIDAR device, the wavelength of the at least one beam is adjustable using a diffractive optical element. The diffractive optical element can be, for example, an interference grating, a volume Bragg grating element, a volume holographic grating element, and the like. Therefore, the beams can be adjusted in terms of their wavelength using a plurality of different and precisely adjustable diffractive optical elements.

According to a further example embodiment of the LIDAR device, the diffractive optical element is situated in the at least one beam source. Semiconductor lasers can be utilized as beam sources that can be spectrally stabilized using optical gratings or using diffractive optical elements. Due to the spectral stabilization, the spectral width of the generated beams is reduced and a central emitted wavelength of a generated beam is exactly established. For example, monolithically integrated gratings, such as in the case of a distributed Bragg reflector laser (DBR) or a distributed feedback laser (DFB), can be utilized in this case.

According to a further preferred example embodiment, the at least two beam sources are single emitters of a laser bar. The single emitters can be surface emitters or edge emitters in this case. Preferably, the single emitters are spaced apart from one another. Using the generating optics, the particular single emitters can be shaped in such a way that they can be utilized as a punctiform grid or linearly for scanning the scanning area.

According to a further example embodiment, multiple beam sources of a laser bar include a shared diffractive optical element. As a result, for example, a typical laser bar can be utilized for generating multiple beams that are spaced apart from one another. The particular wavelength of the generated beams can be adapted using an additional diffractive optical element according to the generating optics and the utilized optical bandpass filter. The diffractive optical element can be situated, for example, between the at least one beam source and the generating optics.

Alternatively, the diffractive optical element can also be situated on the generating optics, for example, in the form of a coating.

According to a further example embodiment of the LIDAR device, the diffractive optical element has a wavelength selectivity that differs across an extension of the diffractive optical element. Preferably, the diffractive optical element has such an extension that all generated or shaped beams are transmitted through the diffractive optical element. Based on the number of generated beams, the diffractive optical element can have areas that are discretely separated from one another and which can each undergo a different wavelength adaptation. For example, a stronger reduction of the wavelengths of the generated beams can therefore be carried out toward an edge of a semiconductor bar than in the center of the semiconductor bar. Alternatively or additionally, the diffractive optical element, along its extension, can continuously adjust or change the wavelength of the generated or shaped beams, for example, according to a linear or quadratic function.

According to a further example embodiment of the LIDAR device, beams are generatable simultaneously or one after the other using the at least two beam sources. In this way, for example, an evaluation of the reflected beams can be simplified when the generated beams are sequentially emitted. Alternatively, all beam sources can simultaneously generate beams continuously or in a pulsed operation. In this way, for example, a punctiform or linear grid for scanning the scanning area can be generated or shaped.

According to a further aspect of the present invention, a method for scanning a scanning area using at least one beam includes generating at least one beam having a defined wavelength. Thereafter, the at least one beam is shaped by a generating optics and is emitted onto a deflection unit at an emission angle. Using the deflection unit, the at least one shaped beam is deflected into a scanning area in a controlled manner in such a way that the entire scanning area is scanned using the at least one beam. A beam reflected on an object is received and registered by a receiving unit. In this case, incoming beams are filtered by a filter situated upstream from the receiving unit, the wavelength of the at least one generated beam being adjusted depending on its emission angle.

In this case, the wavelength of the at least one beam is adapted depending on its emission angle, already during a generation of the at least one beam or during a shaping of the at least one generated beam, in such a way that the generated beam that is subsequently reflected on an object, can transmit through the filter in a loss-free manner. The incidence angle of the at least one reflected beam can also be taken into account during an adaptation of the wavelength of the reflected beam. In this way, a shift of the transmitted wavelength range of the filter at greater incidence angles of reflected beams can be taken into account by correspondingly adjusted wavelengths of the generated beams. Using the method, for example, filters having a smaller transmitted wavelength range can be utilized in order to provide for an improved signal-to-noise ratio and to more effectively suppress spurious reflections.

Preferred example embodiments of the present invention are explained in greater detail in the following with reference to highly simplified schematic representations in the figures, in which the same structural elements each have the same reference numerals.

### BRIEF DESCRIPTION OF THE DRAWINGS

FIG. 1 shows a schematic representation of a transmission path of a LIDAR device according to an example embodiment of the present invention.

FIG. 2 shows a schematic representation of a reception path of a LIDAR device according to an example embodiment of the present invention.

FIGS. 3a-3c show schematic representations of options for adjusting a wavelength using diffractive optical elements of a LIDAR device according to respective example embodiments of the present invention.

FIG. 4 shows a sequence of a method according to an example embodiment of the present invention.

### DETAILED DESCRIPTION

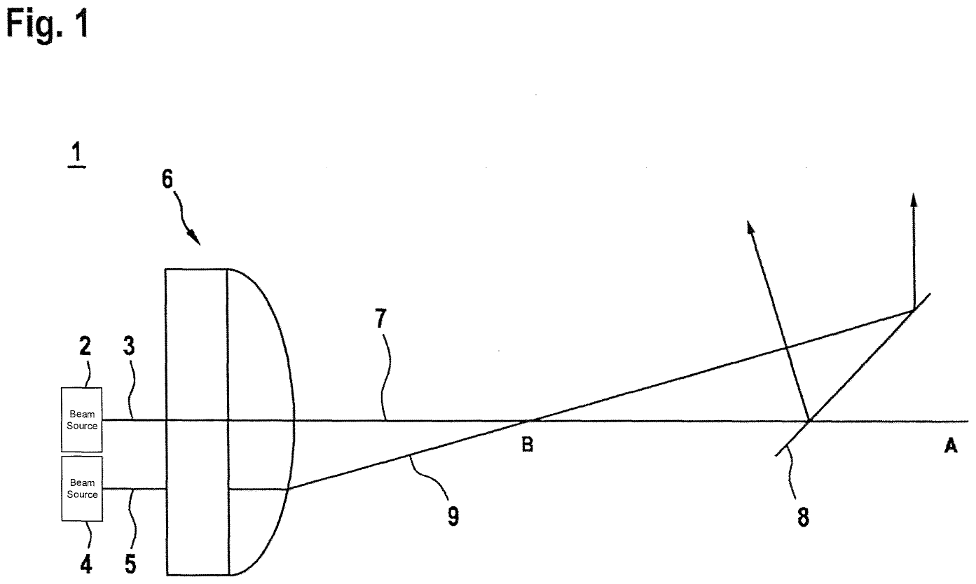

FIG. 1 shows a schematic representation of a transmission path of a LIDAR device 1 according to an example embodiment of the present invention. LIDAR device 1 includes two beam sources 2, 4 that are designed as infrared lasers 2. First beam source 2 is situated in such a way that it emits generated beams 3 that extend along an optical axis of transmission path A. Optical axis A of the transmission path is congruent with an optical axis of a generating optics 6 in this case. Second beam source 4 is spaced apart from first beam source 2. Beam 5 generated by second beam source 4 therefore extends in parallel to optical axis A and is also spaced apart from optical axis A. According to the example embodiment, second beam source 4 generates beams 5 having a wavelength that is smaller than the wavelength of beams 3 generated using first beam source 2. Thereafter, generated beams 3, 5 are shaped by generating optics 6. According to an example embodiment, generating optics 6 is a cylindrical lens 6 that linearly shapes or focuses generated beams 3, 5. Generated beams 3, 5 therefore become shaped beams 7, 9. Due to the focusing, an angular offset is applied, in particular, to generated beams 5 spaced apart from optical axis A. Therefore, shaped beams 7, 9 intersect at a focal point B of generating optics 6 before shaped beams 7, 9 impact a deflection unit 8. In this case, deflection unit 8 is a biaxially swivelable mirror 8 that deflects shaped beams 7, 9 along a horizontal scanning angle and along a vertical scanning angle in a meandering manner. The vertical scanning angle and the horizontal scanning angle cover a scanning area in this case that can be scanned by shaped beams 7, 9. Due to the deviating angle of shaped beams 9 of second beam source 4, these shaped beams 9 are emitted from the LIDAR device at a greater angle into the scanning area.

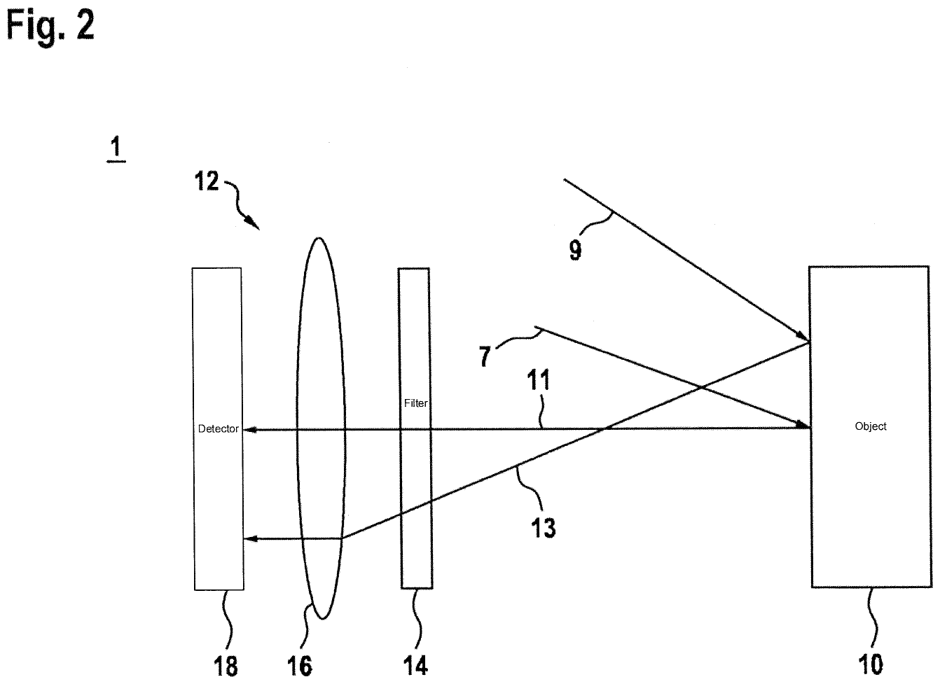

FIG. 2 shows a schematic representation of a reception path of a LIDAR device 1 according to an example embodiment of the present invention, which can be used with the transmission path illustrated in FIG. 1. Emitted, shaped beams 7, 9 can be reflected on objects 10. Due to the reflection, shaped beams 7, 9 become reflected beams 11, 13, respectively. Beams 5, 9 generated by second beam source 4 have an angle in relation to beams 3, 7 generated by first beam source 2. Therefore, objects 10 can be scanned by beams 5, 9 that have a greater angle with respect to LIDAR device 1 than do objects 10 scannable using beams 3, 7. For the sake of simplicity, only one object 10 is represented. Generated, shaped, and subsequently reflected beams 3, 5, 7, 9, 11, 13 can be received by a receiving unit 12. Receiving unit 12 is made up of an optical bandpass filter 14 that is installed upstream from a receiving optics 16. Receiving unit 12 includes a detector 18. Beams 3, 11 that are generated by first beam source 2 and are reflected, impact filter 14 nearly perpendicularly and can transmit through filter 14. Beams 5, 13 that are generated by second beam source 4 and are reflected, impact filter 14 at an angle. Due to the angular offset, a transmitted wavelength range of filter 14 shifts toward shorter wavelengths. Second beam source 4 generates generated beams 5 having a shorter wavelength, so that beams 13 that are generated by second beam source 4 and are reflected, are adapted to the shift of the transmitted wavelength range of filter 14 and can also transmit through filter 14. If reflected beams 13 of second beam source 4 did not have an adapted wavelength, their wavelength would possibly lie outside the transmitted wavelength range of filter 14, due to their angular offset, and would therefore be blocked or reflected by filter 14. Thereafter, the beams transmitted through filter 14 are deflected by receiving optics 16 onto detector 18 and, there, are registered and evaluated.

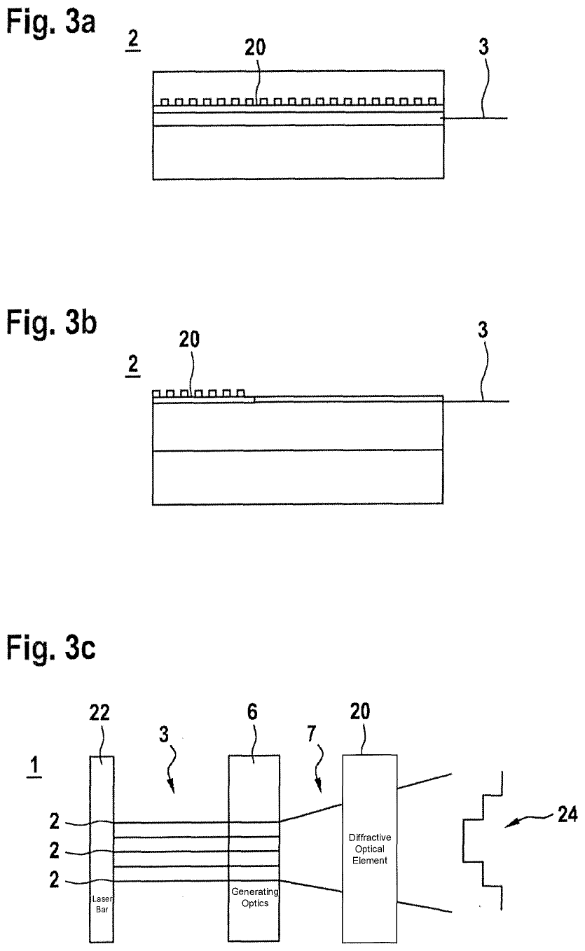

In FIGS. 3a and 3b, wavelength-stabilized beam sources 2 of a LIDAR device 1 are illustrated as internally including diffractive optical elements 20 according to example embodiments of the present invention. FIG. 3a shows a distributed feedback (DFB) laser 2. Diffractive optical element 20 is installed, in the form of a periodic structure in this case, within an active zone of beam source 2 designed as a semiconductor laser. Diffractive optical element 20 filters beams having a certain wavelength already within a resonator of semiconductor laser 2. Depending on a geometry of diffractive optical element 20, beams 3 having a defined set wavelength can be generated. FIG. 3b shows another principle of a wavelength stabilization of a beam source 2. Semiconductor laser 2 is designed as a distributed Bragg reflector (DBR) laser 2 in this case. In this case, diffractive optical element 20 acts as a reflector in an area of the beam source 2. In the case of a LIDAR device 1, differently wavelength-stabilized beam sources 2 can be utilized, also in combination, for generating beams 3, 5.

FIG. 3c shows a portion of a transmission path of a LIDAR device 1 according to another example embodiment. Beam sources 2 are single emitters of a semiconductor laser bar 22 in this case. Beam sources 2 generate multiple beams 3 that are focused by a generating optics 6 into one linearly shaped beam 7. Thereafter, shaped beam 7 passes through a diffractive optical element 20 that introduces a wavelength offset 24 along linear beam 7. In this case, edge regions of linear beam 7 have a shorter wavelength than central areas of linear beam 7.

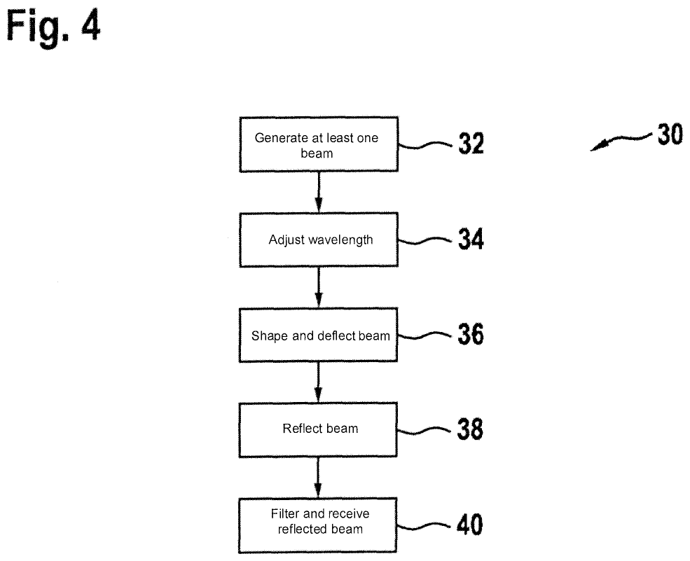

FIG. 4 shows a sequence of a method 30 according to an example embodiment. At step 32, at least one beam is generated. At step 34, a wavelength of the at least one generated beam is adjusted using at least one diffractive optical element or using at least one beam source based on an emission angle and based on a transmitted wavelength range of a filter. Thereafter, at step 36, the at least one beam is shaped and deflected along a scanning area. At step 38, the beams can be reflected on an object. Thereafter, at step 40, the reflected beams are filtered and received.

1-10. (canceled)

11. A LIDAR device for scanning a scanning area, the LIDAR device comprising:
at least two beam sources;
a generating optics;
a receiver; and
an optical bandpass filter;
wherein:
each of the at least two beam sources is configured to generate at least one respective beam having a wavelength that is adjustable depending on an emission angle of the at least one beam;
the generating optics is configured to shape at least one of the generated beam;
the receiver is configured to receive and evaluate at least one beam that is reflected by an object; and
the optical bypass filter is configured to absorb spurious reflections.

12. The LIDAR device of claim 11, wherein the wavelength of the at least one respective beam is adjustable using the at least one beam source.

13. The LIDAR device of claim 11, wherein the wavelength of the at least one respective beam is adjustable using a diffractive optical element provided in the LIDAR device.

14. The LIDAR device of claim 13, wherein the diffractive optical element is situated in the at least one beam source.

15. The LIDAR device of claim 13, wherein the diffractive optical element is situated outside the at least one beam source.

16. The LIDAR device of claim 11, wherein the at least two beam sources are single emitters of a laser bar.

17. The LIDAR device of claim 11, wherein a plurality of the at least two beam sources beam sources are of a laser bar and include a shared diffractive optical element.

18. The LIDAR device of claim 17, wherein the diffractive optical element has a wavelength selectivity that changes across an extension of the diffractive optical element.

19. The LIDAR device of claim 11, wherein the beams of the at least two beam sources are generatable simultaneously the at least two beam sources.

20. The LIDAR device of claim 11, wherein the beams of the at least two beam sources are generatable one after another by the at least two beam sources.

21. The LIDAR device of claim 11, wherein the LIDAR device is configured to perform the scanning of the scanning area using at least two beams that are formed, with respect to a direction from the at least two beam sources, downstream of the generating optics.

22. A method for scanning a scanning area using a LIDAR device that includes at least two beam sources, a generating optics, a receiver, and an optical bypass filter, the method comprising:
using the at least two beam sources, generating at least two beams;
using the generating optics, shaping the at least two beams and then emitting each of the at least two beams at a respective emission angle, wherein respective wavelengths of the emitted beams depend on their respective emission angles;
deflecting the emitted the at least two beams;
receiving, by the receiver, a beam reflected by an object after the reflected beam is filtered through the optical bypass filter.
